(19) United States
(12) Patent Application Publication
(10) Pub. No.: US 2020/0084004 A1
(43) Pub. Date: Mar. 12, 2020

(54) FEEDBACK METHOD AND COMMUNICATION DEVICE

(71) Applicant: NTT DOCOMO, INC., Tokyo (JP)

(72) Inventors: Xin WANG, Beijing (CN); Chongning NA, Beijing (CN); Runxin WANG, Beijing (CN); Lihui WANG, Beijing (CN); Huiling JIANG, Beijing (CN); Satoshi NAGATA, Tokyo (JP)

(73) Assignee: NTT DOCOMO, INC., Tokyo (JP)

(21) Appl. No.: 16/496,107

(22) PCT Filed: Mar. 22, 2018
(86) PCT No.: PCT/CN2018/079930

§ 371 Date: Sep. 20, 2019

(30) Foreign Application Priority Data
Mar. 23, 2017 (CN) 201710179842.1

(51) Int. Cl. H04L 5/00; H04W 72/04; H04W 72/08

(52) U.S. Cl. CPC H04L 5/0055; H04W 72/085; H04W 72/0413

(57) ABSTRACT

Provided in embodiments of the present invention are a feedback method and communication device. The feedback method of the embodiment of the present invention comprises: receiving a data block including multiple code block groups; generating feedback information about the data block according to a receiving status of the multiple code block groups, the feedback information being used to indicate a respective transmission status of at least a part of the code block groups in the multiple code block groups; transmitting the feedback information.

### TECHNICAL FIELD

The present application relates to a field of communication technologies, and in particular, to a feedback method and a communication device.

### BACKGROUND

In a field of wireless communications, a user equipment or mobile station, also referred to as a user equipment (UE), communicates with a base station (BS) over a wireless network, such as a radio access network (RAN). The radio access network (RAN) covers a geographical area, which is generally divided into cell areas, and for each of the cell areas, user equipments within a range of the cell area are served by a base station.

In a data transmission process of the wireless network, when the base station transmits information to the user equipment in a unit of data block (TB), the user equipment may report acknowledgment (ACK) information or non-acknowledgement (NACK) information to the base station for feeding back whether the received data block is correct. When the user equipment feeds the ACK information back to the base station, it indicates that the received data block is correct; and when the user equipment feeds back the NACK information to the base station, it indicates that the received data block is incorrect and the base station needs to retransmit this data block. However, in the prior art, the ACK information or the NACK information fed back by the user equipment can only indicate whether the data block transmitted by the base station is correct or not, and cannot further feed back specific transmission status of code blocks or code block groups included in the data block.

### SUMMARY OF THE INVENTION

According to one aspect of the present invention, a feedback method is provided, comprising: receiving a data block including multiple code block groups; generating, according to receiving status of the multiple code block groups, feedback information about the data block, the feedback information indicating respective transmission status of at least part of the multiple code block groups; and transmitting the feedback information.

According to another aspect of the present invention, a communication device is provided, comprising: a receiving unit configured to receive a data block including multiple code block groups; a processing unit configured to generate, according to receiving status of the multiple code block groups, feedback information about the data block, the feedback information indicating respective transmission status of at least part of the multiple code block groups; and a transmitting unit configured to transmit the feedback information.

With the feedback method and the communication device according to the above aspects of the present invention, specific transmission status of at least part of the code blocks or the code block groups included in the data block transmitted by the base station may be fed back, thereby improving efficiency and reliability of data transmission and reducing delay in the data transmission process.

### BRIEF DESCRIPTION OF THE DRAWINGS

The above and other objects, features and advantages of the present invention will become more apparent by describing embodiments of the present invention in more details with reference to accompanying drawings

FIG. 1 shows a flow chart of a feedback method 100 according to an embodiment of the present invention;

FIG. 2 shows an example of a specific structure of feedback information in an embodiment of the present invention, where FIG. 2(a) shows a structure of the feedback information when each code block group in a data block is transmitted correctly; FIG. 2(b) shows a structure of the feedback information when at least one code block group in the data block is transmitted incorrectly;

FIG. 3 shows a schematic diagram of a structure configuration of feedback information when a data block is transmitted correctly, where FIG. 3(a) is a schematic diagram showing that a feedback information content section is used to feed back a deviation amount of demodulation reference signal DMRS CQI; FIG. 3(b) is a schematic diagram showing that a part of the feedback information content section is used to feed back the DMRS CQI, and a part is used to feed back a partial CSI;

FIG. 4 shows an example of a specific structure of feedback information in an embodiment of the present invention, where FIG. 4(a) shows a structure of the feedback information when all code block groups in a data block are transmitted correctly; FIG. 4(b) and FIG. (c) shows structures of the feedback information when at least one code block group in the data block is transmitted incorrectly; FIG. 4(d) shows a structure of the feedback information when several code block groups in the data block are transmitted incorrectly.

FIG. 5 shows an example of a structure of feedback information in another embodiment of the present invention;

FIG. 6 shows a specific setting manner of the structure of feedback information shown in FIG. 5;

FIG. 7 shows another specific setting manner of the structure of feedback information shown in FIG. 5;

FIG. 8 shows one example of a setting principle of selected transmission status of the code block groups in FIG. 7;

FIG. 9 shows a schematic diagram of performing arithmetic coding according to probabilities of various feedback information in one embodiment of the present invention;

FIG. 10 shows a block diagram of a communication device according to an embodiment of the present invention;

FIG. 11 shows a diagram of an example of a hardware structure of a communication device involved in one embodiment of the present invention.

### DESCRIPTION OF THE EMBODIMENTS

A feedback method and a communication device according to embodiments of the present invention will be described below with reference to accompanying drawings. Throughout the accompanying drawings, the same reference numerals represent the same elements. It is to be understood that the embodiments described herein are merely illustrative and shall not be construed to limit the scope of the present invention.

In a wireless network, when a data block transmitted by a transmitter arrives at a receiver, the receiver may carry out an error detection on the data block, and returns acknowledgment (ACK) information if it is received correctly, or non-acknowledgement (NACK) information if it is received incorrectly. When the transmitter receives the ACK signal, new data is transmitted, otherwise the data block transmitted last time will be retransmitted. In general, the ACK or NACK information may be represented by one bit. For example, the ACK information as the acknowledgment information may be represented by bit 0, and the NACK information as the non-acknowledgement information may be represented by bit 1. Of course, the value of bit 0 or 1 may also be reversed.

When the transmitted data block may be divided into multiple code blocks or code block groups (where each code block may be a segment of data in the data block, that is, a sub-data block, and each code block group may include one or more code blocks), if the above ACK or NACK feedback information, for example, represented by one bit is still adopted, the transmission status of the respective code blocks or code block groups in the data block may not be specifically fed back, resulting in unnecessary data redundancy and channel burden, and reducing efficiency of data transmission.

In view of the above problems, it is considered to propose the following feedback method. FIG. 1 shows a flow chart of a feedback method 100, which may be performed by a mobile station or a base station, according to an embodiment of the present invention.

As described in FIG. 1, in step S101, a data block including multiple code block groups is received. Specifically, the code block groups included in one data block (one transport block TB is one data block) received each time may include one or more code blocks respectively, and the numbers of code blocks included in the respective code block groups may depend on specific transmission settings and transmitted data content.

In step S102, feedback information about the data block is generated according to receiving status of the multiple code block groups, the feedback information indicating respective transmission status of at least part of the multiple code block groups. The feedback information in the embodiments of the present invention no longer simply uses the ACK or NACK to represent whether the transmission status of the entire data block is successful, instead, whether the respective transmission status of at least part of the code block groups in the data block is successful will be specifically reflected in the feedback information. Therefore, the feedback information in the embodiments of the present invention may include more than one bit. Optionally, the number of bits in the feedback information may be related to the number of the code block groups in the data block. For example, the number of bits in the feedback information may be equal to the number of the code block groups in the data block. Of course, the configuration of the above number of bits is merely an example herein, and does not impose any restrictions.

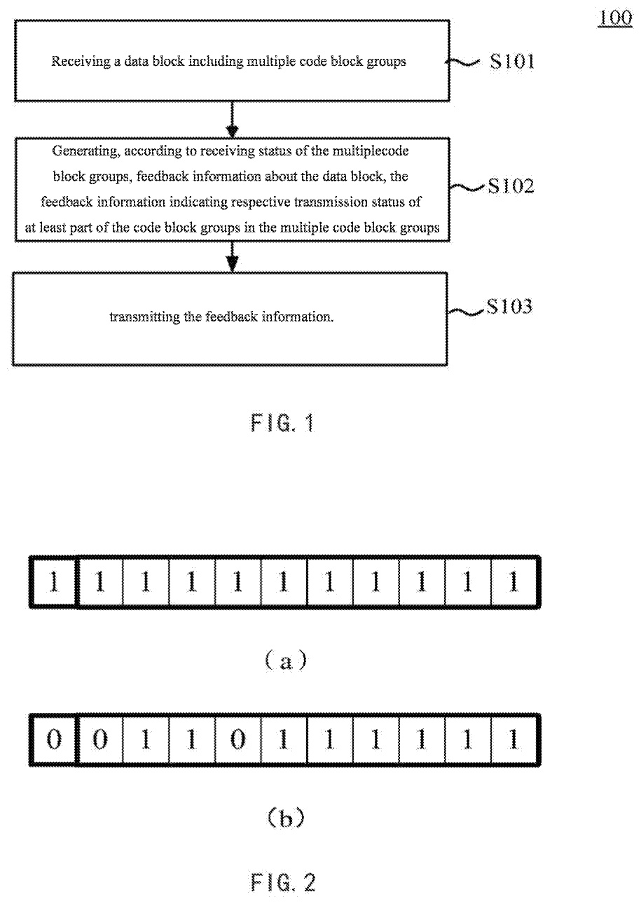

In one embodiment of the present invention, the feedback information may include two parts: a feedback information header and a feedback information content section. Specifically, the feedback information content section may include a bit(s) corresponding to the number of the code block groups in the data block; the feedback information header may be generated according to transmission status of each code block group of the data block. FIG. 2 shows an example of a specific structure of the feedback information in the embodiments of the present invention, where FIG. 2(a) shows a structure of feedback information when there are 10 code block groups in the data block and each code block group is transmitted correctly. In FIG. 2(a), a first bit is the feedback information header, and bit 1 represents that the entire data block is transmitted correctly; the latter 10 bits constitute together the feedback information content section, and each bit corresponds to a code block group at a corresponding location in the data block, and bit 1 is used to represent that the corresponding code block group is transmitted correctly. FIG. 2(b) shows a structure of the feedback information when at least one (2, as shown in the figure) of the 10 code block groups in the data block is transmitted incorrectly. In FIG. 2(b), the first bit is also the feedback information header, and bit 0 represents that at least one code block is transmitted incorrectly in the data block; the latter 10 bits constitute together the feedback information content section, where similar to FIG. 2(a), each bit also corresponds to a code block group at a corresponding location in the data block, and bit 1 is used to represent that the corresponding code block group is transmitted correctly, while bit 0 is used to represent that the corresponding code block group is transmitted incorrectly. As shown in FIG. 2(b), a first code block group and a fourth code block group in a data block currently fed back are transmitted incorrectly, and the rest are all transmitted correctly.

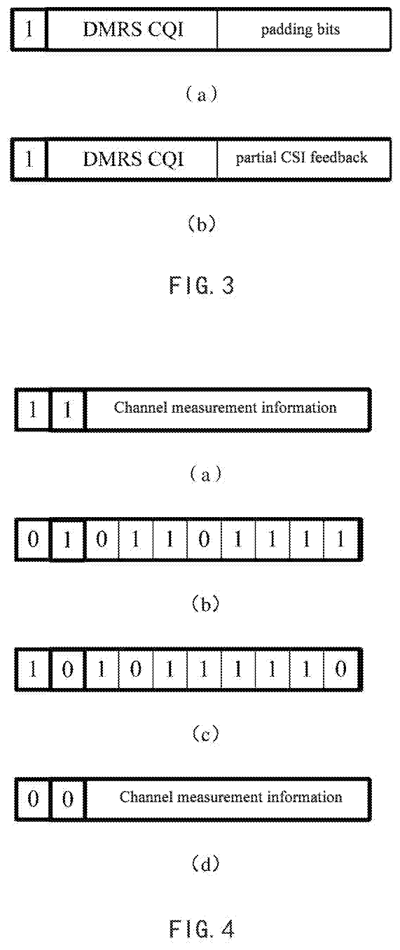

Further, returning to FIG. 2(a), as described above, considering that each code block group in the data block is transmitted correctly, when the feedback information header has fed back information that the entire data block is transmitted correctly, the subsequent feedback information content section does not need to feed back the transmission status of each code block group in the data block bit by bit. In this case, it may be considered at this time to use the feedback information content section to transmit other feedback information, for example, to feed back channel measurement information. The channel measurement information fed back here may be information such as measured channel quality indicator CQI (such as multi-user channel quality indicator MU-CQI), channel state information CSI, and/or signal-to-noise ratio SNR, signal-to-interference-plus-noise ratio (SINR) (that is, a ratio between signal power and energy of interference plus noise), or the like. FIG. 3 shows a schematic diagram of a structure configuration of the feedback information when the data block is transmitted correctly. As shown in FIG. 3(a), the feedback information content section may be used to feed back a deviation amount of demodulation reference signal DMRS CQI for fast feedback and link adaptation, and the remaining bits may be aligned by padding zero in the padding bits. As shown in FIG. 3(b), when a CSI feedback is simultaneously arranged, the feedback information content section may be partly used to feed back the DMRS CQI, and partly used to feed back a partial CSI.

Herein, the multi-user channel quality indicator (MU-CQI) refers to a type of indicators or physical quantities that characterize a quality of a received signal under multi-user transmission conditions. Of course, this term is not a limitation, but rather an example. In fact, a request to implement a similar function (no matter what its name is) is applicable. The deviation amount of the DMRS CQI is calculated as the MU-CQI minus a modulation and coding scheme MCS used by the current data transmission. When the CQI is fed back, an amount of data fed back may be reduced by feeding back this deviation amount. Note that it is exemplified here that the MU-CQI minus the MCS used by the current data transmission is used as the deviation amount (an exemplary deviation amount mentioned in the description that follows is calculated in this way), but the technical solution of the present specification is not limited thereto, and the MCS used by the current data transmission minus the MU-CQI may be used as the deviation amount. Specifically, the deviation amount may include multiple kinds of values, such as 0, a positive deviation amount, or a negative deviation amount, and a value of the deviation amount may be an integer, and of course may be a decimal or may have other value fineness and value range. Optionally, the deviation amount may be +1/−1, +2/−2, 0, or the like. However, the deviation amount +1/−1 or the like here may be an integer difference value between the MCS and the MU-CQI after quantization into integers, and may also represent the difference value in a units of a decimal such as +0.5/−0.5, +0.25/−0.25 or the like between the MCS and the MU-CQI. Non-uniform mapping may also be used, for example, there may be cases with inconsistent intermediate intervals where +1 represents +0.25 difference value, +2 represents +1 difference value, +3 represents +2 difference values, or the like. When feeding back the deviation amount by the feedback information content section, bit 0 may be used to represent that the deviation amount is 0 or positive (that is, a non-negative deviation amount), and bit 1 may be used to represent that the deviation amount is 0 or negative (that is, a non-positive deviation amount). Of course, the value of bit 0 or 1 may also be reversed. Further, it is also possible to represent more values of the deviation amount with more bits, thereby reporting the deviation amount more finely. For example, four values of 2-3 bits may be considered to be utilized to correspond to multiple respective positive deviation amounts or multiple respective negative deviation amounts, the utilization of the bits of the feedback information content section may be improved, and most information or relatively important information of the deviation amount may be represented more finely, while conserving system resources, simplifying system design and reducing the amount of data of the transmission signal. The representations of the above deviation amount are merely examples, and are not limited herein.

Herein, CSI-RS refers to a type of reference signals transmitted in the system for measuring channel state. Of course, this term is not a limitation, but rather an example. In fact, a request to implement a similar function (no matter what its name is) is applicable.

In another embodiment of the present invention, feedback information with a corresponding number of bits may be set according to the number of the code block groups in the data block. The feedback information may include only the feedback information content section capable of feeding back the respective status of each code block group. Of course, it may alternatively include both the feedback information header and the feedback information content section. In the latter case, the number of bits included in the feedback information content section is necessarily smaller than the number of the code block groups in the data block, and the feedback information header may be generated according to the transmission status of each code block group of the data block. In the present embodiment, since the number of bits of the feedback information content section is smaller than the number of the code block groups in the data block, in this case the feedback information content section cannot feed back the respective transmission status of all the code block groups in the data block, and may only feed back transmission status of a part of the code block groups.

FIG. 4 shows an example of a specific structure of feedback information in an embodiment of the present invention, where FIG. 4(a) shows a structure of the feedback information when all code block groups in a data block are transmitted correctly. In FIG. 4(a), the first two bits are set as the feedback information header, and bit 11 represents that the entire block is transmitted correctly. According to the previous discussion, in the feedback information content section, since all the code block groups in the entire data block are transmitted correctly, in this case there is no need to feed back the transmission status of the specific code block groups in the data block. In view of this, the feedback information content section in FIG. 4(a) may be used to feed back the channel measurement information. The number of bits of the feedback information content section is smaller than the number of the code block groups in the data block, and the content and examples of the channel measurement information fed back are as described above, and are not described herein again. The respective numbers of bits included in the feedback information header and the feedback information content section in FIG. 4(a) are merely examples, and may be selected according to practical cases in specific applications, and are not limited herein.

FIG. 4(b) and FIG. 4(c) show structures of the feedback information when at least one of, for example, 10 code block groups in the data block is transmitted incorrectly. Different from the meaning represented by the feedback information header in FIG. 4(a), the feedback information headers of the first two bits in FIG. 4(b) and FIG. 4(c) are used to indicate a location range in the data block of one or more code block groups in the data block that fail in transmission. For example, a feedback information header 01 in FIG. 4(b) is used to indicate that the code block groups in the data block that fail in transmission are located in the range #0-#7 in all the 10 code block groups (0#-9#), while a feedback information header 10 in FIG. 4(c) is used to indicate that the code block groups that fail in transmission in the data block are located in the range #2-#9 in all the 10 code block groups (0#-9#). Correspondingly, in the present embodiment, in order to further represent specific location information of the code block groups that are transmitted incorrectly, the feedback information content sections in FIG. 4(b) and FIG. 4(c) are used to indicate the respective transmission status of at least part of the code block groups within the location range indicated by the feedback information header. Specifically, the feedback information content section in FIG. 4(b) is used to indicate the respective transmission status of the code block groups that fail in transmission in the range #0-#7 in the data block, and in the present embodiment, in the code block groups at locations #0-#7, the code block groups in #0 and #3 fail in transmission; while the feedback information content section in FIG. 4(c) is used to indicate the respective transmission status of the code block groups that fail in transmission in the range #2-#9 in the data block, and in the present embodiment, in the code block groups at locations #2-#9, the code block groups in #3 and #9 fail in transmission. Although since the number of bits in the feedback information content section is smaller than the number of the code block groups in the data block, the feedback information in FIG. 4(b) and FIG. 4(c) cannot completely and accurately represent the transmission status of each code block group in the entire data block, considering that a probability that a small number of (for example, 1 or 2) code block groups are transmitted incorrectly in the data block is the largest, and there is a large probability that the code block groups transmitted incorrectly are concentrated in a certain location range of the data block, therefore, the feedback information in FIG. 4(b) and FIG. 4(c) may feed back the specific transmission status of the respective code block groups in the data block to a large extent. Of course, the structures of feedback information in FIG. 4(b) and FIG. 4(c) are merely examples. In practical applications, the feedback information header may be used to indicate a location range of several consecutive code block groups, or may indicate a location range of several non-consecutive code block groups in a preset indication manner, and is not limited herein. In addition, the numbers of bits respectively included in the feedback information header and the feedback information content section are merely examples and may be selected according to practical cases in specific applications.

FIG. 4(d) shows a structure of the feedback information when several of the 10 code block groups in the data block are transmitted incorrectly. In FIG. 4(d), the first two bits are also the feedback information header, bits 00 are used to represent that the entire data block is transmitted incorrectly, and the latter feedback information content section is used to feed back the channel measurement information. The number of bits of the feedback information content section is smaller than the number of the code block groups in the data block, and the content and examples of the channel measurement information fed back are as described above, and are not described herein again. When more than, for example, 3 code block groups in the 10 code block groups in the data block, are transmitted incorrectly, and thus it is desired to feed back the channel measurement information as soon as possible for link adaptation, or when the code block groups transmitted incorrectly are dispersed in various parts of the data block, and the specific transmission status of the respective code block groups cannot be represented with the limited number of bits of the feedback information content section, it may be considered to feed back with the structure of the feedback information shown in FIG. 4(d). Of course, the applicable scenarios enumerated above are merely examples. In the practical applications, the structure of the feedback information of FIG. 4(d) may be applied in any case where it is desired to firstly feed back the channel measurement information. The numbers of bits respectively included in the feedback information header and the feedback information content section in FIG. 4(d) are merely examples and may be selected according to practical cases in specific applications, and are not limited herein.

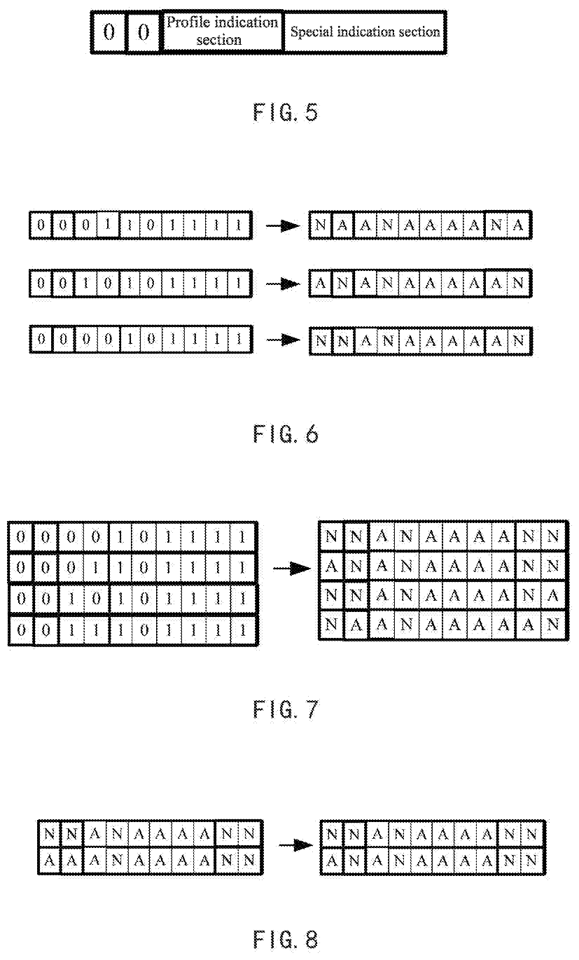

In another embodiment of the present invention, in a similar scenario shown in FIG. 4(d), multiple code block groups in the data block fail in transmission, and the specific location information of the code block groups that fail in transmission cannot be accurately fed back according to the structure of the feedback information shown in FIG. 4(b) or FIG. 4(c). When it is still desired to feed back the status information of the respective code block groups in the data block as much as possible, it may be considered to further indicate the transmission status information of the respective code block groups in the data block with a structure of the feedback information shown in FIG. 5. FIG. 5 shows an example of the structure of the feedback information in another embodiment of the present invention, where the feedback information header included in the feedback information is used to represent that the entire data block is transmitted incorrectly, and may be represented by, for example, two bits 00, and the number of bits of the feedback information content section is smaller than the number of the code block groups in the data block. According to FIG. 5, the first two bits are the feedback information header, bits 00 are used to represent that the entire data block is transmitted incorrectly, and the latter feedback information content section includes two parts: a profile indication section and a special indication section. The special indication section is used to indicate respective transmission status of the code block groups in a preset range, and the number of the code block groups in the preset range equals to the number of bits included in the special indication section. Except the code block groups indicated by the special indication section in the data block, the remaining code block groups are divided into at least two parts (for example, a first part, a second part, and so on) whose transmission status are indicated by bits in the profile indication section. Specifically, respective bits in the profile indication section are in a one-to-one correspondence with the code block groups in the corresponding locations in the first part and the second part. And when one of all the code block groups corresponding to a certain bit fails in transmission, the bit represents that the transmission fails (bit 0). Only when all the code block groups corresponding to this bit are transmitted correctly, the bit indicates the correct transmission (bit 1). The locational relationship between the special indication section and the profile indication section in FIG. 5 is merely an example and is not limited herein.

FIG. 6 shows a specific setting manner of the structure of the feedback information shown in FIG. 5. In FIG. 6, it is assumed that the data block has 10 code block groups, and on the right side of arrows in FIG. 6 are actual transmission status of the respective code block groups in the data block (A for a successful transmission, N for a failed transmission), and on the left side are the feedback information generated according to the transmission status of the respective code block groups in the data block. In this example, the feedback information includes a total of 10 bits, with the first two bits as the feedback information header, the middle two bits as the profile indication section of the feedback information content section, and the last six bits as the special indication section of the feedback information content section. The special indication section is used to indicate specific transmission status of code block groups #2-#7 in the data block, and is in a one-to-one correspondence with the code block groups #2-#7; the profile indication section is used to respectively indicate transmission status of code block groups at locations #0-#1 and #8-#9. It can be seen that when there are multiple code block groups that fail in transmission in the data block, the feedback information header uses bits 00 to represent that the data block fails in transmission, and the special indication section of the feedback information content section uses bits 101111 to respectively indicate the corresponding transmission status of the code block groups #2-#7. According to the respective examples in FIG. 6, when the transmission status of the code block groups at locations #0-#1 and #8-#9 are NA separately, the bits of the profile indication section are represented as 01, and are in one-to-one correspondence with the code block groups #0-#1 and #8-#9 (upper part of FIG. 6); when the transmission status of the code block groups at locations #0-#1 and #8-#9 are AN separately, the bits of the profile indication section are represented as 10, and are in one-to-one correspondence with the code block groups #0-#1 and #8-#9 (middle part of FIG. 6); in particular, when the transmission status of the code block groups #0-#1 are NN, and the transmission status of the code block groups #8-#9 are AN, the bits of the profile indication section are represented as 00; since the first bit 0 of the profile indication section corresponds to the code block groups #0 and #8 respectively where one of the code block groups fails in transmission, the first bit of the profile indication section is represented by 0. The structure of the feedback information shown in FIG. 6 is merely an example, and the specific locations of the code block groups indicated by the profile indication section may be arbitrarily selected, for example, the locations may be #0 and #2 and #1 and #3, or #0-#2 and #4-#6, and are not limited herein.

FIG. 7 shows another specific setting manner of the structure of the feedback information shown in FIG. 5, and the specific structure thereof is similar to that shown in FIG. 6 and also includes a 2-bit feedback information header plus a 2-bit profile indication section plus a 6-bit special indication section. In FIG. 7, with a preset correspondence relationship, an arrangement of the code block groups indicated with the profile indication section in the data block is made correspond to an indication manner of the profile indication section, for example, the profile indication section is represented as 01 when the transmission status of the code block groups are AN and NN, respectively. It is worth emphasizing that the transmission status of the code block groups in FIG. 7 are not necessarily their true transmission status, but selected transmission status acquired according to a certain rule, and FIG. 8 shows one example of a setting principle of the selected transmission status of the code block groups in FIG. 7, where all the code block groups that fail in transmission must be included, and the represented transmission status must be as close as possible to the true transmission status of the code block groups. For example, when the true transmission status of two sets of code block groups are NN, respectively, the selected transmission status are also necessarily NN. When the true transmission status of the two sets of code block groups are AA and NN, respectively, the selected transmission status corresponding to the list in FIG. 7 and acquired according to the above rule need to be AN and NN. With the structure setting of the feedback information shown in FIG. 6 or FIG. 7, the transmission status of the respective code block groups in the data block can be fed back as true as possible, and the system overhead can be reduced as much as possible. The respective numbers of bits of respective component parts (the feedback information header, and the profile indication section and the special indication section of the feedback information content section) of the examples in FIG. 6 and FIG. 7 are not limited herein, furthermore, there may be multiple profile indication sections included in the feedback information, which are respectively used to indicate code block groups in respective different locations.

In still another embodiment of the present invention, the feedback information may also be generated by encoding the respective transmission status of at least part of the multiple code block groups or encoding the respective transmission status of at least part of the multiple code block groups in combination with the channel measurement information. For example, the respective transmission status of at least part of the multiple code block groups and the MU-CQI related deviation amount may be jointly encoded. The way of the encoding here may be source compression coding, which refers to finding, according to statistical characteristics of a symbol sequence output from the source, a certain method, which transforms the symbol sequence output from the source into a shortest codeword sequence, so that an average amount of information carried by each symbol of the latter is maximized, while guaranteeing that the original symbol sequence may be restored without distortion. When encoding using the source compression coding technique, feedback information (feedback information content section) of a variable length or fixed length may be generated. Optionally, when the feedback information includes the feedback information header, and the feedback information content section is of a variable length, the feedback information header may be used to indicate the length of the feedback information content section, that is, the number of bits occupied. The length of the feedback information content section may be a set of a limited number of lengths, such as 4, 8, 12, 16 bits, or the like. When the length of the feedback information content section includes only the above 4 possible lengths, the feedback information header may be set as 2 bits for indicating these 4 possible lengths, respectively. In this case, when an effective source compression coding result included in the feedback information content section is not of one of the above 4 possible lengths and is smaller than a certain length therein, it may be selected to pad zeros after the coding result, or to feed back in combination with other channel feedback information to pad the coding result to one of the length values. Furthermore, when the source compression coding result exceeds a preset maximum of 16 bits, the exception case may be represented by outputting a set feedback value (such as all zeros or all ones of 16 bits, or the like).

In another embodiment, when the length of the feedback information content section is a given length, and when the effective source compression coding result included in the feedback information content section is smaller than this given length, zeros may also be padded after the coding result or the feedback may be carried out in combination with other channel feedback information to pad the coding result to the given length. Conversely, if the source compression coding result exceeds the preset given length, the exception case may be represented by outputting a set feedback value (such as all zeros or all ones of a given length, or the like).

In one embodiment of the present invention, the adopted source compression coding may be carried out by dividing the feedback information into the feedback information header and the feedback information content section. The feedback information header is used to indicate the number of an incorrect code block group(s) in the data block. For example, 11 indicates that all the code block groups are successfully transmitted, 01 indicates that there is one code block group that fails in transmission, 10 indicates that there are two code block groups that fail in transmission, and 00 indicates all the other case than these above cases. The feedback information content section is used to indicate the location of the incorrect code block group(s) in the data block. For example, two 4-bit fields may be utilized to indicate which code block group in the data block fails in transmission. Each 4-bit field is sufficient to indicate all cases where a data block that includes a maximum of 16 data block groups produces a maximum of two errors, for example, 0010 is used to indicate that the code block group #2 in the data block is transmitted incorrectly. When it is not necessary to have so many fields indicate the location of incorrect code block group(s), remaining idle fields may be used for the channel measurement feedback.

In the embodiment of the present invention, the adopted source compression coding may be arithmetic coding. Generally, probabilities of various feedback information to be represented by the arithmetic coding will be estimated first, and then corresponding coding is carried out. FIG. 9 shows a schematic diagram of performing arithmetic coding according to the probabilities of the various feedback information in one embodiment of the present invention. As shown in FIG. 9, in the case where there are 10 code block groups in the data block, on a probability axis, the probability of successful transmission of all code block groups occupies approximately 0-0.35, and there is one possible case; the probability of having one code block group transmitted incorrectly thereof is totally approximately 0.35-0.74, where the probability that each of the 10 code block groups is transmitted incorrectly will occupy 1/10, and there are 10 possible cases in total; further, the probability that two or more code block groups are transmitted incorrectly occupies 0.74-1, where there are 45 possible cases where two code block groups fail in transmission, and 120 possible cases where three code block groups fail in transmission. For the other cases, they will not be further distinguished, and the set NACK feedback value may be directly output.

Further, when considering to combine the probability values in FIG. 9 with five levels of CQI deviation values of CQI ±2, ±1, and 0, the probability occupied by each CQI deviation value is 1/5 in each case. Therefore, in the case where all code block groups are successfully transmitted, the probability ranges occupied by the respective CQI deviation value levels are 0-0.07, 0.07-0.14, 0.14-0.21, 0.21-0.28, and 0.28-0.35, respectively. The case is similar in other probability ranges. After obtaining the above probability distribution results, all (1+10+45+120) cases where a maximum of 3 code block groups of the total 10 code block groups are transmitted incorrectly are combined with the five levels of CQI deviation values, resulting in a total of 885 possibilities. In this regard, in combination with the aforementioned probability distribution, it may be considered to perform encoding with the feedback information content section of no more than 10 bits, for the case where there are five levels of CQI deviation values and the number of code block groups transmitted incorrectly in the data block does not exceed three. The arithmetic coding manner shown in FIG. 9 is merely an example and is not limited herein.

Returning to FIG. 1, in step S103, the feedback information is transmitted.

In the embodiment of the present invention, the data block including 10 code block groups is taken as an example to illustrate the structure of the feedback information of the embodiment of the present invention. In practical applications, the data block may include any number of code block groups, and the feedback information may be adjusted according to the number of code block groups included in the data block correspondingly, which is not limited herein.

With the feedback method of the embodiment of the present invention, the specific transmission status of at least part of the code blocks or the code block groups included in the data block transmitted by the base station may be fed back, thereby improving efficiency and reliability of data transmission and reducing delay in the data transmission process.

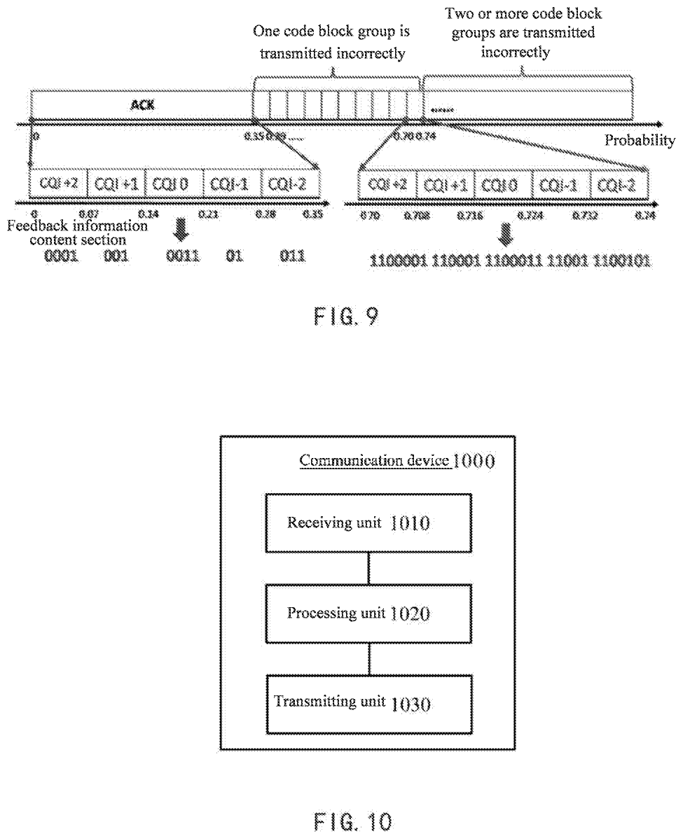

Next, a communication device according to an embodiment of the present invention will be described with reference to FIG. 10. The communication device may perform the above feedback method. Since the operations of the communication device are substantially the same as the steps of the feedback method described above, only a brief description thereof will be made herein, and a repeated description of the same content will be omitted.

As shown in FIG. 10, a communication device 1000 includes a receiving unit 1010, a processing unit 1020, and a transmitting unit 1030. It will be appreciated that FIG. 10 only shows components related to the embodiments of the present invention, while other components are omitted, but this is merely illustrative, and the communication device 1000 may include other components as needed.

The receiving unit 1010 receives a data block including multiple code block groups. Specifically, the code block groups included in one data block (Transport Block, TB) received each time by the receiving unit 1010 may include one or more code blocks respectively, and the numbers of code blocks included in the respective code block groups may depend on specific transmission settings and transmitted data content.

The processing unit 1020 generates feedback information about the data block according to receiving status of the multiple code block groups, the feedback information indicating respective transmission status of at least part of the multiple code block groups. Different from the prior art, the feedback information in the embodiments of the present invention no longer simply uses the ACK or NACK to represent whether the transmission status of the entire data block is successful, instead, whether the respective transmission status of at least part of the code block groups in the data block is successful will be specifically reflected in the feedback information. Therefore, the feedback information in the embodiments of the present invention may include more than one bit. Optionally, the number of bits in the feedback information may be related to the number of the code block groups in the data block. For example, the number of bits in the feedback information may be equal to the number of the code block groups in the data block. Of course, the configuration of the above number of bits is merely an example herein, and does not impose any restrictions.

In one embodiment of the present invention, the feedback information may include two parts: a feedback information header and a feedback information content section. Specifically, the feedback information content section may include a bit(s) corresponding to the number of the code block groups in the data block; the feedback information header may be generated according to transmission status of each code block group of the data block. FIG. 2 shows an example of a specific structure of the feedback information in the embodiments of the present invention, where FIG. 2(a) shows a structure of feedback information when there are 10 code block groups in the data block and each code block group is transmitted correctly. In FIG. 2(a), a first bit is the feedback information header, and bit 1 represents that the entire data block is transmitted correctly; the latter 10 bits constitute together the feedback information content section, and each bit corresponds to a code block group at a corresponding location in the data block, and bit 1 is used to represent that the corresponding code block group is transmitted correctly. FIG. 2(b) shows a structure of the feedback information when at least one (2, as shown in the figure) of the 10 code block groups in the data block is transmitted incorrectly. In FIG. 2(b), the first bit is also the feedback information header, and bit 0 represents that at least one code block is transmitted incorrectly in the data block; the latter 10 bits constitute together the feedback information content section, where similar to FIG. 2(a), each bit also corresponds to a code block group at a corresponding location in the data block, and bit 1 is used to represent that the corresponding code block group is transmitted correctly, while bit 0 is used to represent that the corresponding code block group is transmitted incorrectly. As shown in FIG. 2(b), a first code block group and a fourth code block group in a data block currently fed back are transmitted incorrectly, and the rest are all transmitted correctly.

Further, returning to FIG. 2(a), as described above, considering that each code block group in the data block is transmitted correctly, when the feedback information header has fed back information that the entire data block is transmitted correctly, the subsequent feedback information content section does not need to feed back the transmission status of each code block group in the data block bit by bit. In this case, it may be considered at this time to use the feedback information content section to transmit other feedback information, for example, to feed back channel measurement information. The channel measurement information fed back here may be information such as measured channel quality indicator CQI (such as multi-user channel quality indicator MU-CQI), channel state information CSI, and/or signal-to-noise ratio SNR, or the like. FIG. 3 shows a schematic diagram of a structure configuration of the feedback information when the data block is transmitted correctly. As shown in FIG. 3(a), the feedback information content section may be used to feed back a deviation amount of demodulation reference signal DMRS CQI for fast feedback and link adaptation, and the remaining bits may be aligned by padding zero in the padding bits. As shown in FIG. 3(b), when a CSI feedback is simultaneously arranged, the feedback information content section may be partly used to feed back the DMRS CQI, and partly used to feed back a partial CSI.

Herein, the multi-user channel quality indicator (MU-CQI) refers to a type of indicators or physical quantities that characterize a quality of a received signal under multi-user transmission conditions. Of course, this term is not a limitation, but rather an example. In fact, a request to implement a similar function (no matter what its name is) is applicable. The deviation amount of the DMRS CQI is calculated as the MU-CQI minus a modulation and coding scheme MCS used by the current data transmission. When the CQI is fed back, an amount of data fed back may be reduced by feeding back this deviation amount. Note that it is exemplified here that the MU-CQI minus the MCS used by the current data transmission is used as the deviation amount (an exemplary deviation amount mentioned in the description that follows is calculated in this way), but the technical solution of the present specification is not limited thereto, and the MCS used by the current data transmission minus the MU-CQI may be used as the deviation amount. Specifically, the deviation amount may include multiple kinds of values, such as 0, a positive deviation amount, or a negative deviation amount, and a value of the deviation amount may be an integer, and of course may be a decimal or may have other value fineness and value range. Optionally, the deviation amount may be +1/−1, +2/−2, 0, or the like. However, the deviation amount +1/−1 or the like here may be an integer difference value between the MCS and the MU-CQI after quantization into integers, and may also represent the difference value in a units of a decimal such as +0.5/−0.5, +0.25/−0.25 or the like between the MCS and the MU-CQI. Non-uniform mapping may also be used, for example, there may be cases with inconsistent intermediate intervals where +1 represents +0.25 difference value, +2 represents +1 difference value, +3 represents +2 difference values, or the like. When feeding back the deviation amount by the feedback information content section, bit 0 may be used to represent that the deviation amount is 0 or positive (that is, a non-negative deviation amount), and bit 1 may be used to represent that the deviation amount is 0 or negative (that is, a non-positive deviation amount). Of course, the value of bit 0 or 1 may also be reversed. Further, it is also possible to represent more values of the deviation amount with more bits, thereby reporting the deviation amount more finely. For example, four values of 2-3 bits may be considered to be utilized to correspond to multiple respective positive deviation amounts or multiple respective negative deviation amounts, the utilization of the bits of the feedback information content section may be improved, and most information or relatively important information of the deviation amount may be represented more finely, while conserving system resources, simplifying system design and reducing the amount of data of the transmission signal. The representations of the above deviation amount are merely examples, and are not limited herein.

Herein, CSI-RS refers to a type of reference signals transmitted in the system for measuring channel state. Of course, this term is not a limitation, but rather an example. In fact, a request to implement a similar function (no matter what its name is) is applicable.

In another embodiment of the present invention, the feedback information content section may include the number of bits smaller than the number of the code b6lock groups in the data block; correspondingly, the feedback information header may be generated according to the transmission status of each code block group of the data block. In the present embodiment, since the number of bits of the feedback information content section is smaller than the number of the code block groups in the data block, in this case the feedback information content section cannot feed back the respective transmission status of all the code block groups in the data block, and may only feed back transmission status of a part of the code block groups.

FIG. 4 shows an example of a specific structure of feedback information in an embodiment of the present invention, where FIG. 4(a) shows a structure of the feedback information when all code block groups in a data block are transmitted correctly. In FIG. 4(a), the first two bits are set as the feedback information header, and bit 11 represents that the entire block is transmitted correctly. According to the previous discussion, in the feedback information content section, since all the code block groups in the entire data block are transmitted correctly, in this case there is no need to feed back the transmission status of the specific code block groups in the data block. In view of this, the feedback information content section in FIG. 4(a) may be used to feed back the channel measurement information. The number of bits of the feedback information content section is smaller than the number of the code block groups in the data block, and the content and examples of the channel measurement information fed back are as described above, and are not described herein again. The respective numbers of bits included in the feedback information header and the feedback information content section in FIG. 4(a) are merely examples, and may be selected according to practical cases in specific applications, and are not limited herein.

FIG. 4(b) and FIG. 4(c) show structures of the feedback information when at least one of, for example, 10 code block groups in the data block is transmitted incorrectly. Different from the meaning represented by the feedback information header in FIG. 4(a), the feedback information headers of the first two bits in FIG. 4(b) and FIG. 4(c) are used to indicate a location range in the data block of one or more code block groups in the data block that fail in transmission. For example, a feedback information header 01 in FIG. 4(b) is used to indicate that the code block groups in the data block that fail in transmission are located in the range #0-#7 in all the 10 code block groups (0#-9#), while a feedback information header 10 in FIG. 4(c) is used to indicate that the code block groups that fail in transmission in the data block are located in the range #2-#9 in all the 10 code block groups (0#-9#). Correspondingly, in the present embodiment, in order to further represent specific location information of the code block groups that are transmitted incorrectly, the feedback information content sections in FIG. 4(b) and FIG. 4(c) are used to indicate the respective transmission status of at least part of the code block groups within the location range indicated by the feedback information header. Specifically, the feedback information content section in FIG. 4(b) is used to indicate the respective transmission status of the code block groups that fail in transmission in the range #0-#7 in the data block, and in the present embodiment, in the code block groups in locations #0-#7, the code block groups in #0 and #3 fail in transmission; while the feedback information content section in FIG. 4(c) is used to indicate the respective transmission status of the code block groups that fail in transmission in the range #2-#9 in the data block, and in the present embodiment, in the code block groups in locations #2-#9, the code block groups in #3 and #9 fail in transmission. Although since the number of bits in the feedback information content section is smaller than the number of the code block groups in the data block, the feedback information in FIG. 4(b) and FIG. 4(c) cannot completely and accurately represent the transmission status of each code block group in the entire data block, considering that a probability that a small number of (for example, 1 or 2) code block groups are transmitted incorrectly in the data block is the largest, and there is a large probability that the code block groups transmitted incorrectly are concentrated in a certain location range of the data block, therefore, the feedback information in FIG. 4(b) and FIG. 4(c) may feed back the specific transmission status of the respective code block groups in the data block to a large extent. Of course, the structures of feedback information in FIG. 4(b) and FIG. 4(c) are merely examples. In practical applications, the feedback information header may be used to indicate a location range of several consecutive code block groups, or may indicate a location range of several non-consecutive code block groups in a preset indication manner, and is not limited herein. In addition, the numbers of bits respectively included in the feedback information header and the feedback information content section are merely examples and may be selected according to practical cases in specific applications.

FIG. 4(d) shows a structure of the feedback information when several of the 10 code block groups in the data block are transmitted incorrectly. In FIG. 4(d), the first two bits are also the feedback information header, bits 00 are used to represent that the entire data block is transmitted incorrectly, and the latter feedback information content section is used to feed back the channel measurement information. The number of bits of the feedback information content section is smaller than the number of the code block groups in the data block, and the content and examples of the channel measurement information fed back are as described above, and are not described herein again. When more than, for example, 3 code block groups in the 10 code block groups in the data block, are transmitted incorrectly, and thus it is desired to feed back the channel measurement information as soon as possible for link adaptation, or when the code block groups transmitted incorrectly are dispersed in various parts of the data block, and the specific transmission status of the respective code block groups cannot be represented with the limited number of bits of the feedback information content section, it may be considered to feed back with the structure of the feedback information shown in FIG. 4(d). Of course, the applicable scenarios enumerated above are merely examples. In the practical applications, the structure of the feedback information of FIG. 4(d) may be applied in any case where it is desired to firstly feed back the channel measurement information. The numbers of bits respectively included in the feedback information header and the feedback information content section in FIG. 4(d) are merely examples and may be selected according to practical cases in specific applications, and are not limited herein.

In another embodiment of the present invention, in a similar scenario shown in FIG. 4(d), multiple code block groups in the data block fail in transmission, and the specific location information of the code block groups that fail in transmission cannot be accurately fed back according to the structure of the feedback information shown in FIG. 4(b) or FIG. 4(c). When it is still desired to feed back the status information of the respective code block groups in the data block as much as possible, it may be considered to further indicate the transmission status information of the respective code block groups in the data block with a structure of the feedback information shown in FIG. 5. FIG. 5 shows an example of the structure of the feedback information in another embodiment of the present invention, where the feedback information header included in the feedback information is used to represent that the entire data block is transmitted incorrectly, and may be represented by, for example, two bits 00, and the number of bits of the feedback information content section is smaller than the number of the code block groups in the data block. According to FIG. 5, the first two bits are the feedback information header, bits 00 are used to represent that the entire data block is transmitted incorrectly, and the latter feedback information content section includes two parts: a profile indication section and a special indication section. The special indication section is used to indicate respective transmission status of the code block groups in a preset range, and the number of the code block groups in the preset range equals to the number of bits included in the special indication section. Except the code block groups indicated by the special indication section in the data block, the remaining code block groups are divided into at least two parts (for example, a first part, a second part, and so on) whose transmission status are indicated by bits in the profile indication section. Specifically, respective bits in the profile indication section are in a one-to-one correspondence with the code block groups in the corresponding locations in the first part and the second part. And when one of all the code block groups corresponding to a certain bit fails in transmission, the bit represents that the transmission fails (bit 0). Only when all the code block groups corresponding to this bit are transmitted correctly, the bit indicates the correct transmission (bit 1). The locational relationship between the special indication section and the profile indication section in FIG. 5 is merely an example and is not limited herein.

FIG. 6 shows a specific setting manner of the structure of the feedback information shown in FIG. 5. In FIG. 6, it is assumed that the data block has 10 code block groups, and on the right side of arrows in FIG. 6 are actual transmission status of the respective code block groups in the data block (A for a successful transmission, N for a failed transmission), and on the left side are the feedback information generated according to the transmission status of the respective code block groups in the data block. In this example, the feedback information includes a total of 10 bits, with the first two bits as the feedback information header, the middle two bits as the profile indication section of the feedback information content section, and the last six bits as the special indication section of the feedback information content section. The special indication section is used to indicate specific transmission status of code block groups #2-#7 in the data block, and is in a one-to-one correspondence with the code block groups #2-#7; the profile indication section is used to respectively indicate transmission status of code block groups in locations #0-#1 and #8-#9. It can be seen that when there are multiple code block groups that fail in transmission in the data block, the feedback information header uses bits 00 to represent that the data block fails in transmission, and the special indication section of the feedback information content section uses bits 101111 to respectively indicate the corresponding transmission status of the code block groups #2-#7. According to the respective examples in FIG. 6, when the transmission status of the code block groups in locations #0-#1 and #8-#9 are NA separately, the bits of the profile indication section are represented as 01, and are in one-to-one correspondence with the code block groups #0-#1 and #8-#9 (upper part of FIG. 6); when the transmission status of the code block groups in locations #0-#1 and #8-#9 are AN separately, the bits of the profile indication section are represented as 10, and are in one-to-one correspondence with the code block groups #0-#1 and #8-#9 (middle part of FIG. 6); in particular, when the transmission status of the code block groups #0-#1 are NN, and the transmission status of the code block groups #8-#9 are AN, the bits of the profile indication section are represented as 00; since the first bit 0 of the profile indication section corresponds to the code block groups #0 and #8 respectively where one of the code block groups fails in transmission, the first bit of the profile indication section is represented by 0. The structure of the feedback information shown in FIG. 6 is merely an example, and the specific locations of the code block groups indicated by the profile indication section may be arbitrarily selected, for example, the locations may be #0 and #2 and #1 and #3, or #0-#2 and #4-#6, and are not limited herein.

FIG. 7 shows another specific setting manner of the structure of the feedback information shown in FIG. 5, and the specific structure thereof is similar to that shown in FIG. 6 and also includes a 2-bit feedback information header plus a 2-bit profile indication section plus a 6-bit special indication section. In FIG. 7, with a preset correspondence relationship, an arrangement of the code block groups indicated with the profile indication section in the data block is made correspond to an indication manner of the profile indication section, for example, the profile indication section is represented as 01 when the transmission status of the code block groups are AN and NN, respectively. It is worth emphasizing that the transmission status of the code block groups in FIG. 7 are not necessarily their true transmission status, but selected transmission status acquired according to a certain rule, and FIG. 8 shows one example of a setting principle of the selected transmission status of the code block groups in FIG. 7, where all the code block groups that fail in transmission must be included, and the represented transmission status must be as close as possible to the true transmission status of the code block groups. For example, when the true transmission status of two sets of code block groups are NN, respectively, the selected transmission status are also necessarily NN. When the true transmission status of the two sets of code block groups are AA and NN, respectively, the selected transmission status corresponding to the list in FIG. 7 and acquired according to the above rule need to be AN and NN. With the structure setting of the feedback information shown in FIG. 6 or FIG. 7, the transmission status of the respective code block groups in the data block can be fed back as true as possible, and the system overhead can be reduced as much as possible. The respective numbers of bits of respective component parts (the feedback information header, and the profile indication section and the special indication section of the feedback information content section) of the examples in FIG. 6 and FIG. 7 are not limited herein, furthermore, there may be multiple profile indication sections included in the feedback information, which are respectively used to indicate code block groups in respective different locations.

In still another embodiment of the present invention, the feedback information may also be generated by encoding the respective transmission status of at least part of the multiple code block groups or encoding the respective transmission status of at least part of the multiple code block groups in combination with the channel measurement information. For example, the respective transmission status of at least part of the multiple code block groups and the MU-CQI related deviation amount may be jointly encoded. The way of the encoding here may be source compression coding, which refers to finding, according to statistical characteristics of a symbol sequence output from the source, a certain method, which transforms the symbol sequence output from the source into a shortest codeword sequence, so that an average amount of information carried by each symbol of the latter is maximized, while guaranteeing that the original symbol sequence may be restored without distortion. When encoding using the source compression coding technique, feedback information (feedback information content section) of a variable length or fixed length may be generated. Optionally, when the feedback information includes the feedback information header, and the feedback information content section is of a variable length, the feedback information header may be used to indicate the length of the feedback information content section, that is, the number of bits occupied. The length of the feedback information content section may be a set of a limited number of lengths, such as 4, 8, 12, 16 bits, or the like. When the length of the feedback information content section includes only the above 4 possible lengths, the feedback information header may be set as 2 bits for indicating these 4 possible lengths, respectively. In this case, when an effective source compression coding result included in the feedback information content section is not of one of the above 4 possible lengths and is smaller than a certain length therein, it may be selected to pad zeros after the coding result, or to feed back in combination with other channel feedback information to pad the coding result to one of the length values. Furthermore, when the source compression coding result exceeds a preset maximum of 16 bits, the exception case may be represented by outputting a set feedback value (such as all zeros or all ones of 16 bits, or the like).

In another embodiment, when the length of the feedback information content section is a given length, and when the effective source compression coding result included in the feedback information content section is smaller than this given length, zeros may also be padded after the coding result or the feedback may be carried out in combination with other channel feedback information to pad the coding result to the given length. Conversely, if the source compression coding result exceeds the preset given length, the exception case may be represented by outputting a set feedback value (such as all zeros or all ones of a given length, or the like).

In one embodiment of the present invention, the adopted source compression coding may be carried out by dividing the feedback information into the feedback information header and the feedback information content section. The feedback information header is used to indicate the number of an incorrect code block group(s) in the data block. For example, 11 indicates that all the code block groups are successfully transmitted, 01 indicates that there is one code block group that fails in transmission, 10 indicates that there are two code block groups that fail in transmission, and 00 indicates all the other case than these above cases. The feedback information content section is used to indicate the location of the incorrect code block group(s) in the data block. For example, two 4-bit fields may be utilized to indicate which code block group in the data block fails in transmission. Each 4-bit field is sufficient to indicate all cases where a data block that includes a maximum of 16 data block groups produces a maximum of two errors, for example, 0010 is used to indicate that the code block group #2 in the data block is transmitted incorrectly. When it is not necessary to have so many fields indicate the location of incorrect code block group(s), remaining idle fields may be used for the channel measurement feedback.

In the embodiment of the present invention, the adopted source compression coding may be arithmetic coding. Generally, probabilities of various feedback information to be represented by the arithmetic coding will be estimated first, and then corresponding coding is carried out. FIG. 9 shows a schematic diagram of performing arithmetic coding according to the probabilities of the various feedback information in one embodiment of the present invention. As shown in FIG. 9, in the case where there are 10 code block groups in the data block, on a probability axis, the probability of successful transmission of all code block groups occupies approximately 0-0.35, and there is one possible case; the probability of having one code block group transmitted incorrectly thereof is totally approximately 0.35-0.74, where the probability that each of the 10 code block groups is transmitted incorrectly will occupy 1/10, and there are 10 possible cases in total; further, the probability that two or more code block groups are transmitted incorrectly occupies 0.74-1, where there are 45 possible cases where two code block groups fail in transmission, and 120 possible cases where three code block groups fail in transmission. For the other cases, they will not be further distinguished, and the set NACK feedback value may be directly output.

Further, when considering to combine the probability values in FIG. 9 with five levels of CQI deviation values of CQI ±2, ±1, and 0, the probability occupied by each CQI deviation value is 1/5 in each case. Therefore, in the case where all code block groups are successfully transmitted, the probability ranges occupied by the respective CQI deviation value levels are 0-0.07, 0.07-0.14, 0.14-0.21, 0.21-0.28, and 0.28-0.35, respectively. The case is similar in other probability ranges. After obtaining the above probability distribution results, all (1+10+45+120) cases where a maximum of 3 code block groups of the total 10 code block groups are transmitted incorrectly are combined with the five levels of CQI deviation values, resulting in a total of 885 possibilities. In this regard, in combination with the aforementioned probability distribution, it may be considered to perform encoding with the feedback information content section of no more than 10 bits, for the case where there are five levels of CQI deviation values and the number of code block groups transmitted incorrectly in the data block does not exceed three. The arithmetic coding manner shown in FIG. 9 is merely an example and is not limited herein.

Returning to FIG. 10, the transmitting unit 1030 transmits the feedback information.

In the embodiment of the present invention, the data block including 10 code block groups is taken as an example to illustrate the structure of the feedback information of the embodiment of the present invention. In practical applications, the data block may include any number of code block groups, and the feedback information may be adjusted according to the number of code block groups included in the data block correspondingly, which is not limited herein.

The communication device 1000 in the embodiment of the present invention may be a base station or a user equipment. Correspondingly, the feedback information in the embodiment of the present invention may be an uplink transmission or a downlink transmission.

With the communication device of the embodiment of the present invention, the specific transmission status of at least part of the code blocks or the code block groups included in the data block transmitted by the base station may be fed back, thereby improving efficiency and reliability of data transmission and reducing delay in the data transmission process.

Additionally, block diagrams used for the illustration of the above embodiments represent functional blocks in functional units. These functional blocks (components) are realized by any combination of hardware and/or software. In addition, the means for implementing the respective function blocks is not particularly limited. That is, the respective functional blocks may be realized by one apparatus that is physically and/or logically aggregated; or more than two apparatuses that are physically and/or logically separated may be directly and/or indirectly (e.g., wiredly and/or wirelessly) connected, and the respective functional blocks may be implemented by these apparatuses.

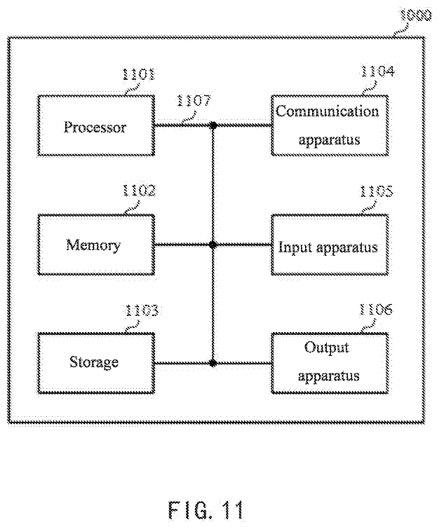

For example, the communication device 1000, which may be a wireless base station or a user terminal, in an embodiment of the present invention can function as a computer that carries out the processes of the wireless communication method of the present invention. FIG. 11 is a diagram that shows an example of a hardware structure of the communication device according to an embodiment of the present invention. The above described communication device 1000 may be physically constituted as a computer apparatus including a processor 1101, a memory 1102, a storage 1103, a communication apparatus 1104, an input apparatus 1105, an output apparatus 1106, a bus 1107 and so on.

It should be noted that, in the following description, the term “apparatus” may be interpreted as a circuit, a device, a unit or the like. The hardware constitution of the communication device 1000 may include one or more apparatuses shown in the figure, or may not include a part of the apparatuses.

For example, although only one processor 1101 is shown, a plurality of processors may be provided. Furthermore, processes may be performed by one processor, or processes may be performed either simultaneously or in sequence, or in different manners, by two or more processors. Additionally, the processor 1101 may be installed with one or more chips.

Respective functions of the communication device 1000 are implemented by, for example, reading predetermined software (program) onto hardware such as the processor 1101 and the memory 1102, so as to make the processor 1101 perform calculations, controlling the communication carried out by the communication apparatus 1104, and controlling the reading and/or writing of data in the memory 1102 and the storage 1103.

The processor 1101 may control the whole computer by, for example, running an operating system. The processor 1101 may be configured with a central processing unit (CPU), which includes interfaces with peripheral apparatus, a control apparatus, a computing apparatus, a register and so on.

Furthermore, the processor 1101 reads programs (program codes), software modules, data or the like, from the storage 1103 and/or the communication apparatus 1104, into the memory 1102, and executes various processes according to them. As the programs, programs to allow a computer to execute at least part of the operations described in the above-described embodiments may be used.

The memory 1102 is a computer-readable recording medium, and may be constituted by, for example, at least one of a ROM (Read Only Memory), an EPROM (Erasable Programmable ROM), an EEPROM (Electrically EPROM), a RAM (Random Access Memory) and/or other appropriate storage media. The memory 1102 may be referred to as a “register”, a “cache”, a “main memory” (primary storage apparatus) and so on. The memory 1102 can store executable programs (program codes), software modules and so on for implementing the radio communication methods according to embodiments of the present invention.

The storage 1103 is a computer-readable recording medium, and may be constituted by, for example, at least one of a flexible disk, a floppy (registered trademark) disk, a magneto-optical disk (for example, a compact disc (CD-ROM (Compact Disc ROM) and so on), a digital versatile disc, a Blu-ray (registered trademark) disk), a removable disk, a hard disk drive, a smart card, a flash memory device (for example, a card, a stick, a key drive, etc.), a magnetic stripe, a database, a server, and/or other appropriate storage media. The storage 1103 may be referred to as a secondary storage apparatus.

The communication apparatus 1104 is hardware (transmitting/receiving device) for allowing inter-computer communication by using wired and/or wireless networks, and may be referred to as, for example, a network device, a network controller, a network card, a communication module and so on. The communication apparatus 1104 may be configured to include a high frequency switch, a duplexer, a filter, a frequency synthesizer and so on in order to realize, for example, frequency division duplex (FDD) and/or time division duplex (TDD).

The input apparatus 1105 is an input device for receiving input from the outside (for example, a keyboard, a mouse, a microphone, a switch, a button, a sensor or the like). The output apparatus 1106 is an output device for implementing output to the outside (for example, a display, a speaker, an LED (Light Emitting Diode) lamp, or the like). It should be noted that the input apparatus 1105 and the output apparatus 1106 may be provided in an integrated structure (for example, a touch panel).

Furthermore, these apparatus, including the processor 1101, the memory 1102 and so on are connected by the bus 1107 for communicating information. The bus 1107 may be formed with a single bus, or may be formed with buses that vary between apparatus.

Also, the communication device 1000 may include hardware such as a microprocessor, a digital signal processor (DSP), an ASIC (Application-Specific Integrated Circuit), a PLD (Programmable Logic Device), an FPGA (Field Programmable Gate Array) and so on, and part or all of the functional blocks may be implemented by the hardware. For example, the processor 1101 may be installed with at least one of these pieces of hardware.

It should be noted that the terms illustrated in the present specification and/or the terms required for the understanding of the present specification may be substituted with terms having the same or similar meaning. For example, a channel and/or a symbol may be a signal (signaling). In addition, the signal may be a message. A reference signal may be abbreviated as a RS (Reference Signal), and may be referred to as a pilot, a pilot signal and so on, depending on the standard applied. In addition, a component carrier (CC) may be referred to as a carrier frequency, a cell, a frequency carrier, or the like.

Furthermore, a slot may be comprised of one or more symbols (OFDM (Orthogonal Frequency Division Multiplexing) symbols, SC-FDMA (Single Carrier Frequency Division Multiple Access) symbols, or the like) in the time domain. Furthermore, the slot may also be a time unit configured based on a parameter. Furthermore, a slot may also include multiple micro-slots. Each micro-slot may be comprised of one or more symbols in the time domain. Furthermore, a micro-slot may also be referred as a sub-slot.

A radio frame, a subframe, a slot, a micro-slot and a symbol all represent the time unit when transmitting signals. A radio frame, a subframe, a slot, a micro-slot and a symbol may also use other names that correspond to them. For example, one subframe may be referred to as a transmission time interval (TTI), a plurality of consecutive subframes may also be referred to as a TTI, and one slot or one micro-slot may also be referred to as a “TTI.” That is, the subframe and/or the TTI may be a subframe (1 ms) in existing LTE, may be a shorter period of time than 1 ms (for example, one to thirteen symbols), or may be a longer period of time than 1 ms. It should be noted that a unit indicating the TTI may also be referred to as a slot, a micro-slot, or the like instead of a subframe.

Here, the TTI refers to a minimum time unit of scheduling in radio communication, for example. For example, in LTE systems, a radio base station performs, for respective user equipment, the scheduling to assign radio resources (such as frequency bandwidths and transmission powers that can be used in the respective user equipment) in a unit of TTI. It should be noted that the definition of the TTI is not limited to this.

The TTI may be a transmission time unit for a channel-coded data packet (data block), a code block, and/or a codeword, or may be a processing unit for scheduling, link adaptation and so on. It should be noted that, when a TTI is given, a time interval (e.g., the number of symbols) actually mapped to a data block, a code block, and/or a codeword may be shorter than the TTI.

It should be noted that, when one slot or one micro-slot is called a TTI, more than one TTI (i.e., more than one slot or more than one micro-slot) may become a minimum time unit for scheduling. Furthermore, the number of slots (the number of micro-slots) constituting the minimum time unit for scheduling may be controlled.

A TTI having a time duration of 1 ms may be referred to as a normal TTI (TTI in LTE Rel. 8 to 12), a standard TTI, a long TTI, a normal subframe, a standard subframe, or a long subframe, or the like. A TTI that is shorter than a normal TTI may be referred to as a shortened TTI, a short TTI, a partial (or fractional) TTI, a shortened subframe, a short subframe, a micro-slot, a short micro-slot, or the like.

It should be noted that, a long TTI (e.g., a normal TTI, a subframe, etc.) may be replaced with a TTI having a time duration exceeding 1 ms, and a short TTI (e.g., a shortened TTI, etc.) may also be replaced with a TTI having a TTI duration which is shorter than that of the long TTI and exceeds 1 ms.

A resource block (RB) is a unit of resource allocation in the time domain and the frequency domain, and may include one or a plurality of consecutive subcarriers in the frequency domain. Also, an RB may include one or more symbols in the time domain, and may be one slot, one micro-slot, one subframe or one TTI duration. One TTI and one subframe each may be comprised of one or more resource blocks, respectively. It should be noted that one or more RBs may also be referred to as a physical resource block (PRB (Physical RB)), a Sub-Carrier Group (SCG), a Resource Element Group (REG), a PRG pair, an RB pair, and so on.

It should be noted that the above-described structures of radio frames, subframes, slots, micro-slots, symbols and so on are simply examples. For example, configurations such as the number of subframes included in a radio frame, the number of slots of each subframe or radio frame, the number or micro-slots included in a slot, the number of symbols and RBs included in a slot or micro-slot, the number of subcarriers included in an RB, the number of symbols in a TTI, the symbol length, the cyclic prefix (CP) length and so on can be variously changed.

Also, the information, parameters and so on described in this specification may be represented in absolute values or in relative values with respect to predetermined values, or may be represented in other corresponding information. For example, radio resources may be indicated by predetermined indices. In addition, equations to use these parameters and so on may be different from those explicitly disclosed in this specification.

The names used for parameters and so on in this specification are not limited in any respect. For example, since various channels (PUCCH (Physical Uplink Control Channel), PDCCH (Physical Downlink Control Channel) and so on) and information elements can be identified by any suitable names, the various names assigned to these various channels and information elements are not limited in any respect.

The information, signals and so on described in this specification may be represented by using any one of various different technologies. For example, data, instructions, commands, information, signals, bits, symbols, chips and so on, which may be referenced throughout the herein-contained description, may be represented by voltages, currents, electromagnetic waves, magnetic fields or particles, optical fields or photons, or any combination of them.

Also, information, signals and so on can be output from higher layers to lower layers and/or from lower layers to higher layers. Information, signals and so on may be input and/or output via a plurality of network nodes.

The information, signals and so on that are input and/or output may be stored in a specific location (for example, in a memory), or may be managed in a management table. The information, signals and so on that are input and/or output may be overwritten, updated or appended. The information, signals and so on that are output may be deleted. The information, signals and so on that are input may be transmitted to other apparatus.

Reporting of information is by no means limited to the aspects/embodiments described in this specification, and other methods may be used as well. For example, reporting of information may be implemented by using physical layer signaling (for example, downlink control information (DCI), uplink control information (UCI)), higher layer signaling (for example, RRC (Radio Resource Control) signaling, broadcast information (the master information block (MIB), system information blocks (SIBs) and so on), MAC (Medium Access Control) signaling and so on), and other signals and/or combinations of them.

It should be noted that physical layer signaling may also be referred to as L1/L2 (Layer 1/Layer 2) control information (L1/L2 control signals), L1 control information (L1 control signal) and so on. Also, RRC signaling may be referred to as “RRC message”, and can be, for example, an RRC connection setup message, RRC connection reconfiguration message, and so on. Also, MAC signaling may be reported using, for example, MAC control elements (MAC CE (Control Element)).

Also, reporting of predetermined information does not necessarily have to be carried out explicitly, and can be carried out implicitly (by, for example, not reporting this piece of information, or by reporting a different piece of information).

Regarding decisions, they may be made by values represented by one bit (0 or 1), may be made by a true or false value (Boolean value) represented by true or false, or may be made by comparison of numerical values (for example, comparison against a predetermined value).

Software, whether referred to as software, firmware, middleware, microcode or hardware description language, or called by other names, should be interpreted broadly, to mean commands, command sets, codes, code segments, program codes, programs, subprograms, software modules, applications, software applications, software packages, routines, subroutines, objects, executable files, execution threads, steps, functions and so on.

Also, software, commands, information and so on may be transmitted or received via transmission media. For example, when software is transmitted from a website, a server or other remote sources by using wired technologies (coaxial cables, optical fiber cables, twisted-pair cables, digital subscriber lines (DSL) and so on) and/or wireless technologies (infrared radiation, microwaves and so on), these wired technologies and/or wireless technologies are included in the definition of transmission media.

The terms “system” and “network” as used herein are used interchangeably.

In the present specification, the terms “base station (BS)”, “radio base station”, “eNB”, “gNB”, “cell”, “sector”, “cell group”, “carrier” and “component carrier” may be used interchangeably. A base station may be referred to as a “fixed station”, “NodeB”, “eNodeB (eNB)”, “access point”, “transmission point”, “receiving point”, “femto cell”, “small cell” and so on.

A base station can accommodate one or more (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part or all of the coverage area of a base station and/or a base station subsystem that provides communication services within this coverage.

In the present specification, the terms “mobile station (MS)”, “user terminal”, “user equipment (UE)” and “terminal” may be used interchangeably. A base station may be referred to as a “fixed station”, “NodeB”, “eNodeB (eNB)”, “access point”, “transmission point”, “receiving point”, “femto cell”, “small cell” and so on.

Sometimes a user terminal is also called by those skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms.

Furthermore, the radio base stations in this specification may be replaced by user equipment. For example, each aspect/embodiment of the present invention may be applied to a configuration in which communication between a radio base station and a user equipment is replaced with communication among a plurality of user equipment (D2D (Device-to-Device)). In this case, user equipment 20 may have the functions of the radio base stations 10 described above. In addition, terms such as “uplink” and “downlink” may be replaced by “side.” For example, an uplink channel may be replaced by a side channel.

Likewise, the user equipment in this specification may be replaced by radio base stations.

In the present specification, it is assumed that certain actions to be performed by base station may, in some cases, be performed by its higher node (upper node). In a network comprised of one or more network nodes with base stations, it is clear that various operations that are performed to communicate with terminals can be performed by base stations, one or more network nodes (for example, MMEs (Mobility Management Entities), S-GW (Serving-Gateways), and so on)other than base stations, or combinations of them.

The respective aspects/embodiments illustrated in this specification may be used individually or in combinations, or may be switched and used during execution. The order of processes, sequences, flowcharts and so on of the respective aspects/embodiments described in the present specification may be re-ordered as long as inconsistencies do not arise. For example, although various methods have been illustrated in this specification with various components of steps in exemplary orders, the specific orders that are illustrated herein are by no means limiting.

The aspects/embodiments illustrated in this specification may be applied to systems that use LTE (Long Term Evolution), LTE-A (LTE-Advanced), LTE-B (LTE-Beyond), SUPER 3G (Super 3th generation mobile communication system), IMT-Advanced (International Mobile Telecommunications-Advanced), 4G (4th generation mobile communication system), 5G (5th generation mobile communication system), FRA (Future Radio Access), New-RAT (Radio Access Technology), NR (New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark) and other proper radio communication methods, and/or next-generation systems that are enhanced based on them.

The phrase “based on” as used in this specification does not mean “based only on”, unless otherwise specified. In other words, the phrase “based on” means both “based only on” and “based at least on.”

Any reference to elements with designations such as “first”, “second” and so on as used herein does not generally limit the number/quantity or order of these elements. These designations are used only for convenience, as a method of distinguishing between two or more elements. In this way, reference to the first and second elements does not imply that only two elements may be employed, or that the first element must precede the second element in some way.

The terms “judge” and “determine” as used herein may encompass a wide variety of actions. For example, regarding “judging (determining)”, calculating, computing, processing, deriving, investigating, looking up (for example, looking up a table, a database or some other data structure), ascertaining and so on may be considered as “judging (determining)”. Furthermore, regarding “judging (determining)”, receiving (for example, receiving information), transmitting (for example, transmitting information), inputting, outputting, accessing (for example, accessing data in a memory) and so on may be considered as “judging (determining)”. In addition, regarding “judging (determining)”, resolving, selecting, choosing, establishing, comparing and so on may be considered as “judging (determining)”. In other words, regarding “judging (determining)”, some actions may be considered as “judging (determining)”.

As used herein, the terms “connected” and “coupled”, or any variation of these terms, mean all direct or indirect connections or coupling between two or more elements, and may include the presence of one or more intermediate elements between two elements that are “connected” or “coupled” to each other. The coupling or connection between the elements may be physical, logical or a combination of them. For example, “connection” may be replaced as “access.” As used herein, two elements may be considered “connected” or “coupled” to each other by using one or more electrical wires, cables and/or printed electrical connections, and, as a number of non-limiting and non-inclusive examples, by using electromagnetic energy having wavelengths in radio frequency fields, microwave regions and/or optical (both visible and invisible) regions.

When terms such as “include”, “comprise” and variations of them are used in this specification or in claims, these terms are intended to be inclusive, in a manner similar to the way the term “provide” is used. Furthermore, the term “or” as used in this specification or in claims is intended to be not an exclusive disjunction.

Although the present invention has been described in detail above, it should be obvious to a person skilled in the art that the present invention is by no means limited to the embodiments described herein. The present invention can be implemented with various corrections and in various modifications, without departing from the spirit and scope of the present invention defined by the recitations of claims. Consequently, the description herein is provided only for the purpose of explaining examples, and should by no means be construed to limit the present invention in any way.

1-12. (canceled)

13. A communication device comprising:
a receiving unit configured to receive a data block including multiple code block groups;
a processing unit configured to generate, according to receiving status of the multiple code block groups, feedback information about the data block, the feedback information indicating respective transmission status of at least part of the code block groups in the multiple code block groups; and
a transmitting unit configured to transmit the feedback information.

14. The communication device of claim 13, wherein
the feedback information includes a feedback information header and a feedback information content section.

15. The communication device of claim 14, wherein
the feedback information content section includes bits corresponding to the number of code block groups in the data block; and
the feedback information header is generated according to transmission status of each code block group of the data block.

16. The communication device of claim 15, wherein
when the feedback information header indicates that the transmission of the data block succeeds, the feedback information content section is used to feed channel measurement information back.

17. The communication device of claim 15, wherein
when the feedback information header indicates that the transmission of the data block fails, the feedback information content section is used to indicate respective transmission status of each of the multiple code block groups.

18. The communication device of claim 14, wherein
the feedback information content section includes the number of bits smaller than the number of code block groups in the data block; and
the feedback information header is generated according to transmission status of each code block group of the data block.

19. The communication device of claim 18, wherein
when the feedback information header indicates that the transmission of the data block succeeds, the feedback information content section is used to feed channel measurement information back.

20. The communication device of claim 18, wherein
the feedback information header is used to indicate a location range in the data block of one or more code block groups in the data block that fail in transmission; and
the feedback information content section is used to indicate respective transmission status of the at least part of the code block groups in the location range indicated by the feedback information header.

21. The communication device of claim 18, wherein
when the feedback information header indicates that the transmission of the data block fails, the feedback information content section is used to feed the channel measurement information back.

22. The communication device of claim 13, wherein
the feedback information is generated by encoding the respective transmission status of the at least part of the code block groups in the multiple code block groups; or
the feedback information is generated by jointly encoding the respective transmission status of the at least part of the code block groups in the multiple code block groups and channel measurement information.

23. The communication device of claim 22, wherein
the encoding is source compression coding.

24. The communication device of claim 23, wherein
the feedback information includes a feedback information header and a feedback information content section, and the feedback information header is used to indicate the number of bits of the feedback information content section.

25. A feedback method comprising:
receiving a data block including multiple code block groups;
generating, according to receiving status of the multiple code block groups, feedback information about the data block, the feedback information indicating respective transmission status of at least part of the code block groups in the multiple code block groups;
transmitting the feedback information.
